(19) United States
(12) Patent Application Publication
(10) Pub. No.: US 2009/0084242 A1
(43) Pub. Date: Apr. 2, 2009

(54) HOLE PUNCH WITH JAM RELEASE CLIP

(75) Inventors: BRIAN E. MELGAARD, Boonton, NJ (US); CHAD TERRY, Lunenburg, MA (US); JONATHAN N. TOWLE, Amherst, NH (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: ACCENTRA, INC., Newtown, PA (US)

(21) Appl. No.: 12/187,944

(22) Filed: Aug. 7, 2008

Related U.S. Application Data
(60) Provisional application No. 60/975,763, filed on Sep. 27, 2007.

(51) Int. Cl. B26F 1/14

(52) U.S. Cl. 83/686

(57) ABSTRACT

A hole punch apparatus with a jam release clip coupled to a push rod and a punch pin, wherein the push rod passes through a hole formed in a side of the clip, and wherein the punch pin is secured to the clip by a pair of parallel fingers at one end of the clip that engage two flat grooves formed in the sides of the punch pin. A handle of the hole punch apparatus pivots about a pivot rod, which handle front end is linked to the punch pin via the jam release clip. Pressing down on the handle advances the punch pin to cut a hole in a paper stack held inside a paper slot, and lifting up on the handle withdraws the punch pin out of the paper stack.

### CROSS-REFERENCE TO RELATED APPLICATIONS

This is a non-provisional application from which priority is based on provisional application No. 60/975,763, filed Sep. 27, 2007, whose entire contents are hereby incorporated by reference.

### BACKGROUND

The present invention relates to a hole punch, and more specifically, to a punch for making a plurality of holes in a medium such as paper.

Paper hole punches are common devices found in offices, schools, and homes. Hole punches serve to punch or cut holes into one or more sheets of paper, plastic film, cardboard, etc. The result is that the punched paper or sheet media can then be organized and stored in a binder or fastened within a file.

The working principle of the common hole punch is straightforward. A lever arm is hinged to a base, and one or more punch pins are actuated by the lever arm. When a user presses down on the lever, the cutting ends of the punch pins are advanced through the paper stack and the punched out chads or disk-shaped chips are pushed into a receptacle in the base.

The punch pins and lever are then retracted by the user lifting up on the lever, or by releasing the lever so that a reset spring can return the parts to their respective start positions.

Care should be taken to ensure that the cutting points do not jam from the accumulated chips resulting from repeated hole punching operations that cut through multi-sheet stacks of paper. Improper tearing of the paper or collection of paper perforation chips near or within the peripheral moving parts can cause the punch pins to jam and/or lodge in the paper, thus seizing the hole punch, or at least making the reset step stiff to the user, or diminishing the effectiveness of the reset spring. Moreover, jammed paper chips can easily lead to distortion and damage to hole punch parts, and dulling of the cutting points.

To avoid this problem, scrap collection receptacles have been included in hole punches, as disclosed in, for example, U.S. Pat. No. 7,270,042 (Mori et al.). Such a receptacle or reservoir serves to collect and keep the paper perforation chips away from the cutting points, and consequently reduce the chance of jamming the device due to debris collecting near or within the moving parts.

While the Mori paper punch is one approach of how to avoid device jamming, it suffers from several drawbacks. For example, the apparatus does not take into account that improper tearing in the paper by the punch pin generates undesirable friction or drag on the punch pin, or that the paper shreds can jam the elevating or reset mechanism. If the reset mechanism becomes jammed, there is no way to return the apparatus to its starting state without manually removing the jam and returning the reset mechanism by hand. Since the lever is not directly linked to the reset mechanism or the punch pin, when the handle must be reset by hand in such a paper jam, the device remains inoperable until cleaned.

Given these drawbacks, and more may be apparent to one skilled in the art, there is a need for an improved hole punch that allows a user to safely and effectively return the apparatus to its starting state without manually removing the jam and resetting the elevating unit, and, which will stroke after stroke, cut into a paper stack with repeated reliability such as to reduce the unnecessary tearing of paper or malformed holes which lead to further jamming.

### SUMMARY OF THE INVENTION

Briefly summarized, the present invention is directed to a manually operated hole punch for punching a hole in a stack of sheet media such as papers, comprising a punch pin frame having a stacked media slot; a lever pivotably mounted to the frame, wherein the lever includes a front portion in front of the pivot and a pressing area behind the pivot; a push rod disposed at the front portion of the lever; a jam release clip having an opening at one end to receive the push rod and an engagement member at the opposite end; a punch pin having cutting points at one end and a base at an opposite end, the punch pin slidably fitted to the frame wherein the cutting points end passes into the stacked media slot and the base is proximate to the push rod, and wherein the engagement member of the jam release clip latches to the punch pin; and wherein pushing at the pressing area pivots the lever in a first direction which drives the push rod into the base end of the punch pin and advances the cutting points end at least partially into the stacked media slot, and lifting up at the pressing area pivots the lever in a second direction which via the jam release clip withdraws the cutting points end at least partially out of the stacked media slot.

It is an advantage of the claimed invention that lifting on the handle retracts the punch pin in the event of a paper jam or when the punch pin gets lodged in the paper stack. It is also an advantage of the claimed invention that the jam release clip eliminates the rotational movement in the punch pin and ensures that the V-notch at the cutting point of the punch pin is held in a specific rotational or angular orientation to the paper stack to be cut, thereby greatly increasing the reliability and efficiency of the paper punching while reducing tearing of the paper, malformed holes or a serrated or uneven lips around the hole, which is unsatisfactory to the user and may also contribute to unnecessary jamming of the device.

These and other objectives of the claimed invention will become obvious to those of ordinary skill in the art after reading the following detailed description of the preferred embodiments that are illustrated in the various drawing figures.

### BRIEF DESCRIPTION OF THE DRAWINGS

FIG. 1 is a perspective, cross-sectional view of a preferred embodiment hole punch according to the present invention with the housing removed to expose the internal details.

FIG. 2 is a perspective view of the hole punch of FIG. 1 showing the housing cutaway to reveal the internal details.

FIG. 3 is a perspective view of the jam release clip and punch pin.

FIG. 4 is a perspective view of the punch pin frame assembly.

FIG. 5 is a side elevational view of the hole punch.

FIG. 6 is a rear elevational view of the hole punch with the housing removed to expose the internal details.

### DETAILED DESCRIPTION OF THE PREFERRED EMBODIMENTS

This description is not to be taken in a limiting sense, but is made merely for the purpose of illustrating the general principles of the invention. The section titles and overall organization of the present detailed description are for the purpose of convenience only and are not intended to limit the present invention. Accordingly, the invention will be described with respect to a jam release clip for a hole punch. The hole punch can be of a design having a punch pin driven manually by a handle that pivots on a hinge at one end. It is to be understood that the methods and devices described herein is for illustration only. The invention also applies to other methods and devices for hole punch designs having a need for jam release capability.

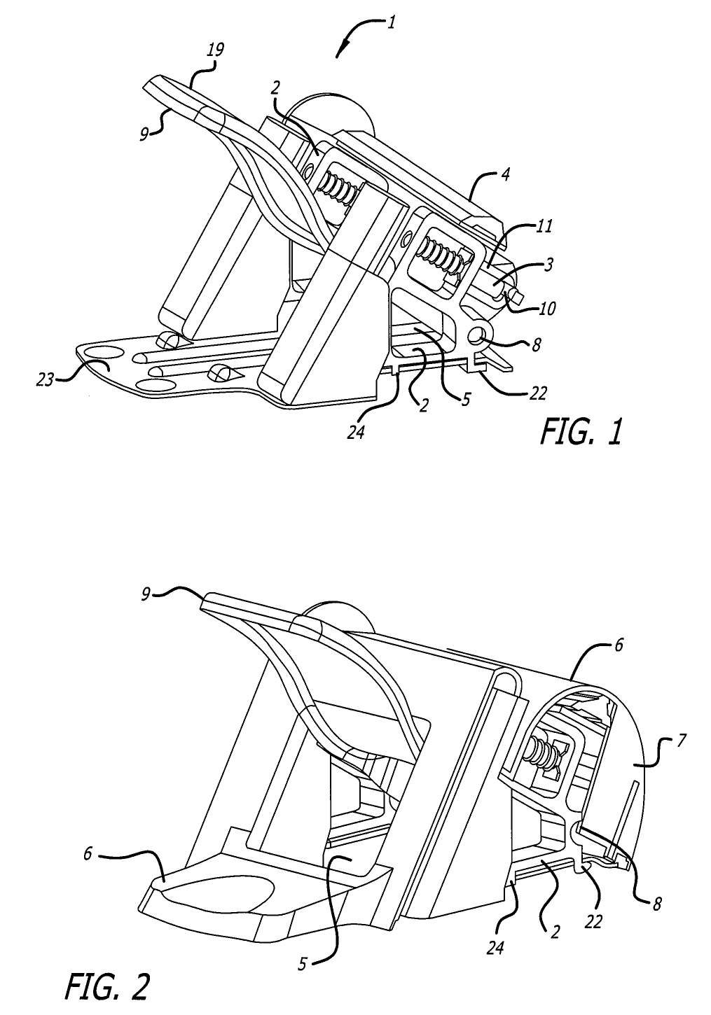

FIGS. 1 and 2 show cutaway perspective views of a preferred embodiment hole punch 1. Hole punch 1 contains two punch elements 2 (also called punch frames), each retaining at least one punch pin 3 therein. In various alternative embodiments, there can be more or fewer than the two punch elements 2 depicted in the drawings. Punch pins 3 reciprocate within each punch element 2. The chads or punched paper cutouts (not shown) are expelled from the paper stack (not shown) when punch pin 3 cuts through the thickness of the stack. Those cutouts or chads once detached from the paper stack drop into a chip container or reservoir 5 inside the body or housing 6. One or more optional, helical reset springs 4 coaxially assembled to punch pin 3 assist in withdrawing punch pin 3 from the cut hole in the stack of papers.

A preferred embodiment top cover or housing 6 is shown. Housing 6 has a molded-in rib 7 that confines pivot rod 8 on which handle 9 is hinged, and prevents pivot rod 8 from “walking out” or working its way out and disassembling from punch element 2. This allows pivot rod 8 to be made from a single piece without any machining operations to accommodate retaining clips, collars, or pins. In an alternative embodiment, the same part can be used for push rod 10 (to drive the punch pin 3) and pivot rod 8 (which is a hinge for the handle 9), because they may be the same diameter and length. In other words, the identical part can be used as push rod 10 or pivot rod 8. This creates further parts savings. This is possible because of the improvements noted above by use of jam release clips 11 and features of housing 6.

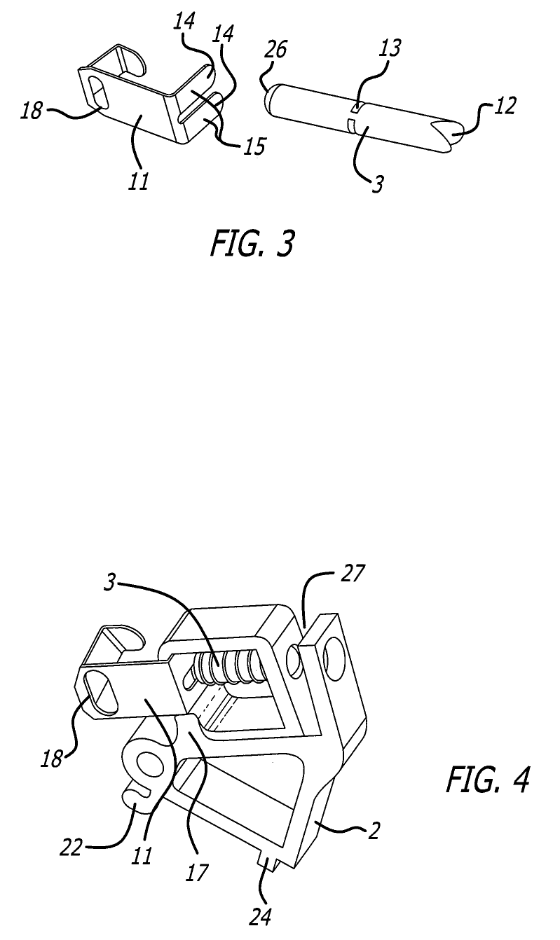

FIGS. 3 and 4 show the preferred embodiment jam release clip 11. The jam release clip 11 is made from flat sheet material and formed into a rectangular U-shape with a hook or flange at one end and a pair of fingers 14 at the opposite end. An oval opening or hole 18 is also located adjacent the hooked end. FIG. 3 shows punch pin 3 next to and disassembled from a preferred embodiment jam release clip 11. Each punch pin 3 has a cylindrical shape with a V-notch cutting point 12 at one end that is designed to cut into multiple sheets of sheet media such as a stack of papers, and a blunt base 26 at the opposite end. Of course, the cutting points 12 can be of different designs and cutting profiles. Base 26 preferably has a smooth finish for low friction.

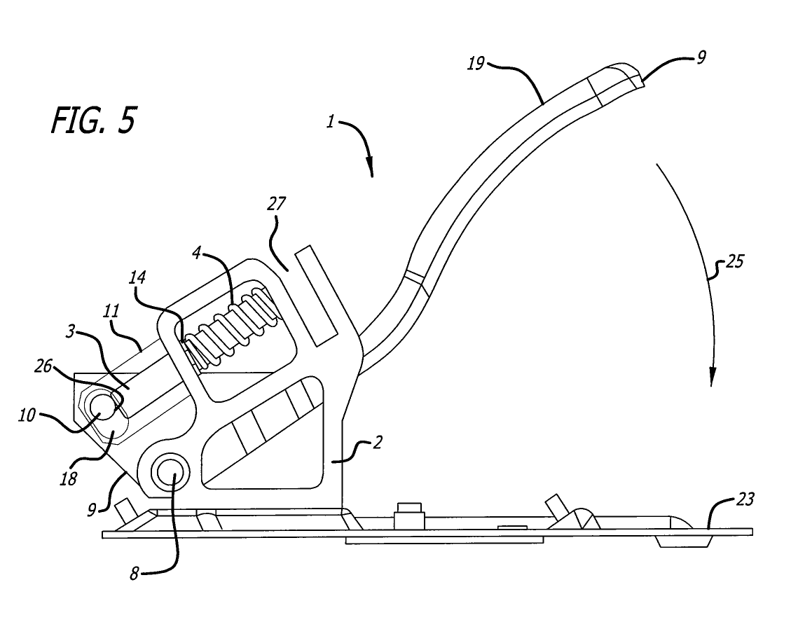

Jam release clip 11 extends at least partially alongside the shaft of punch pin 3 and is assembled to it as shown in FIG. 5 by frictional engagement to a formation such as a groove 13 formed in punch pin 3. The handle forces for retracting pins are thus transferred to punch pin 3 through jam release clip 11 and specifically through an engagement member, here a pair of parallel fingers 14 engaging a complementary formation in the punch pin 3; here the formation is a slot or groove 13. This is seen in FIGS. 3, 4. Of course, in various alternative embodiments, the engagement member may be linked to the punch pin via other linkages such a pin in the punch pin captured within an eyelet formed in the jam release clip, or the engagement member may be welded or soldered to the punch pin.

Jam release clip 11 thus replaces a conventional E-clip or collar ring, which would otherwise be needed to hold punch pin reset spring 4 in place. Reset spring 4 provides the force needed to reset handle 9 to its start position as mentioned above. By modifying hole punch 1 to accept the present invention jam release clip 11, the chances for hole punch 1 jamming during normal operation are greatly diminished. The resulting hole punch has a much improved, hitch-free operation as perceived by the user.

Another advantage of the jam release clip 11 is that it holds the rotational orientation of punch pin 3 and prevents significant rotation of punch pin 3 in the assembly. To do this, as seen in FIG. 3, jam release clip 11 relies on the pair of parallel fingers 14 having flat edges 15 therebetween. Flat edges 15 of jam release clip 11 align with flat grooves 13 in punch pin 3; flat edges 15 slide over and mesh with respective flat grooves 13 in punch pin 3. The complementary flat surfaces 15 of fingers 14 and groove 13 thus prevent unwanted, incidental rotational movement of punch pin 3 when it is assembled to and used in punch pin element 2 (FIG. 4). In an alternative embodiment, the pair of fingers and complementary flat surfaces may be replaced by a single rectangular cross-sectioned finger fitting into a complementary shaped recess such as a key fitting within a partial keyhole.

Jam release clip 11 is preferably made from a compliant material (spring steel, plastic, rubber, etc.) so the pair of fingers 14 can be resiliently snapped around the diameter of pin 3 and locked into place. Another flat surface 16 of jam release clip 11 engages a flat surface 17 of the frame of punch element 2, which keeps jam release clip 11 aligned to punch element 2 and therefore pin 3 to punch element 2. This arrangement also has jam release clip 11 at least partially extending alongside of punch pin 3. The fingers 14 still must have a certain degree of strength and rigidity not to flex too much so as to transmit sufficient force to pull the punch pin 3 out from a paper stack if it becomes lodged therein or encounters high friction from sliding inside the hole.

To be sure, an uneven lip at the cutting point 12 generates undesirable friction or drag on punch pin 3. Any tearing action also requires greater user-applied effort at handle 9 since tearing of the paper generates more resistance than normal shearing of the paper from a proper cut. These factors causing increased user effort are avoided in the present invention hole punch by consistent, rotational orientation of cutting points 12 to the paper stack.

Eliminating the rotational movement in punch pin 3 ensures that the V-notch at the cutting point 12 of punch pin 3 is held in a specific rotational or angular orientation to the paper stack to be cut. Once cutting point 12 of punch pin 3 can be oriented consistently, stroke after stroke, then how (i.e., which cutting point edge 12 cuts first, the angle of the punch pin's angle of entry into the paper stack, etc.) cutting points 12 cut into the paper can be predicted so that each stroke cutting into the paper stack can be repeated reliably and efficiently. This improves the consistency of the cuts and minimizes chances of poorly formed holes in the paper. A bad cut may also lead to tearing of the paper instead of shearing of the paper in a proper cut. The tearing in the paper creates a malformed hole or a serrated or uneven lip around the hole, which is unsatisfactory to the user and may create further problems in seizing up the hole punch as described earlier.

As seen in FIGS. 1 and 4, jam release clip 11 has an elongated hole 18 formed in the side through which push rod 10 passes, creating a linkage. The elongated hole 18 accommodates some slop in the movement of push rod 10 therein during the advancement and withdraw strokes of handle 9. Push rod 10 is connected to handle 9 and depending on the direction of the force applied on handle pressing area 19, push rod 10 can directly push on punch pin 3 or indirectly pull on punch pin 3. Pushing on punch pin 3 advances pin 3 for the cutting stroke and pulling on punch pin 3 withdraws punch pin 3 in the event of a paper jam or when punch pin 3 gets lodged in the paper stack. Specifically, in the pushing, cutting, or advancement stroke, the actuation force passes from handle 9 to push rod 10 and to punch pin 3 via base end 26. The push rod 10 and base end 26 may be proximate to or touching each other. The linkage between fingers 14 and punch pin groove 13 may or may not be involved in the pushing or cutting stroke.

FIG. 5 is a side elevational view of hole punch 1 with the housing removed to reveal the internal components. The left side of FIG. 5 is the front of hole punch 1 and the right side is the back end. To summarize the action, FIG. 5 depicts handle 9 that is pivoted to frame 2 at pivot rod 8, wherein a front portion of handle 9 is on one side of the pivot toward the front end, and pressing area 19 of the lever is on the opposite side of the pivot near the back end. A downward, advancement cutting stroke 25 and pivot action of handle 9 drive punch pin 3 in a direction backward and upward toward paper slot 27 and pressing area 19 of the handle (in FIG. 5, a clockwise motion of lever about pivot rod 8). All punch pins 3 are arranged with their cutting points 12 aimed toward and adjacent to paper slot 27 and handle pressing area 19 in the exemplary embodiment of FIGS. 1-6.

Again in FIG. 5, in a withdraw stroke, lifting up on handle 9 from underneath pressing area 19 pivots the front portion of handle 9 downward (in FIG. 5, moving handle 9 counterclockwise around pivot rod 8), which translates push rod 10 captured within the front portion of the handle downward in an arc 20. As push rod 10 moves downward, it pulls on jam release clip 11 via the elongated hole 18 that it passes through. As jam release clip 11 gets pulled downward, the opposite end of jam release clip 11 with two fingers 14 pulls on punch pin 3 at groove 13, which pulling action retracts punch pin 3 away from paper slot 27 and out of the paper stack that rests within the paper slot. During the withdraw stroke, the linkage of fingers 14 of jam release clip 11 to punch pin groove 13 bears the entire load. In a manually operated punch pin, enabling a withdrawing action via the jam release clip is highly beneficial to avoid any jams, seizing, or malfunction in the device.

In one aspect of the preferred embodiment, jam release clip 11 hooks around and confines the end of push rod 10 (FIG. 1) to prevent push rod 10 from “walking off” or sliding off engagement with punch pin 3. Beneficially, this design allows push rod 10 to be made from a single piece without any machining operations needed for clips, collar rings, retention pins, etc., and prevents the unwanted “walking” mentioned above. The reduced part count, ease of manufacturing, and assembly all contribute to reduced cost, yet results in a more reliably operating hole punch. Jam release clip 11 is designed for use on both sides of hole punch 1. It does not require two unique parts.

In an alternative embodiment, jam release clip 11 eliminates compression reset spring 4 on each punch element 2—in the FIGS. 1 and 2 embodiment, the two compression springs 4 are replaced with a single reset spring (not shown) mounted to handle 9. Such a reset spring can be a compression spring, leaf or bar spring, or torsion spring linked to the handle and urging it toward the start position. Since handle 9 is directly linked to pin 3, as handle 9 is reset, the biasing force from the single, handle reset spring can withdraw punch pins 3 from the paper stack.

Punch pin element 2 is essentially a rigid chassis or frame to which is assembled punch pins 3, reset springs 4, pivot pins 8, and other components. Punch pin element 2 (or punch frame) is preferably fairly rigid to resist the structural distorting forces generated when punching through a thick stack of papers, which rigidity ensures ideal alignment of the papers with punch pin cutting points 12 and efficient transmission of forces from handle 9 to punch pin 3. As best seen in FIGS. 1 and 4, punch pin element 2 has a downward extending, L-shaped foot 22 at the bottom of element 2. This foot 22 conveniently allows for easy installation and eliminates the need for a fastener to be used to secure it to base plate 23 of hole punch 1, as seen in FIG. 5.

Punch pin element 2 further includes a downward extending alignment tab 24 at the opposite end of element 2 to the L-shaped foot 22. As seen in FIGS. 1 and 4, alignment tab 24 permits punch pin element 2 to be assembled to housing 6 and registered precisely and securely in base plate 23. Foot 22 hooks into base plate 23 as seen in FIGS. 1 and 2. Its orientation is such that when pressing handle 9 to punch paper, foot 22 reacts against base plate 23 and is held tightly in place.

FIG. 5 is a side elevational view of hole punch 1 where housing 6 has been removed to expose the internal mechanism. Handle pressing area 19 is up high and all internal components are in the start position. In the cutting stroke, a user depresses handle 9 in a downward stroke 25 at pressing area 19, which handle 9 is hinged at the opposite end at pivot rod 8. The portion of the handle in front of pivot rod 8 thus moves upward and in the direction of punch pin 3 (clockwise about pivot rod 8); that front portion of handle 9 also translates push rod 10. Specifically, push rod 10 pushes on base 26 of punch pin 3, which action linearly advances the opposite, cutting point end 12 of punch pin 3 into paper slot 27 and through the stack of papers (not shown). The stack of papers rests partially inside the near-vertically opening slot 27 near cutting point end 12 of punch pin 3.

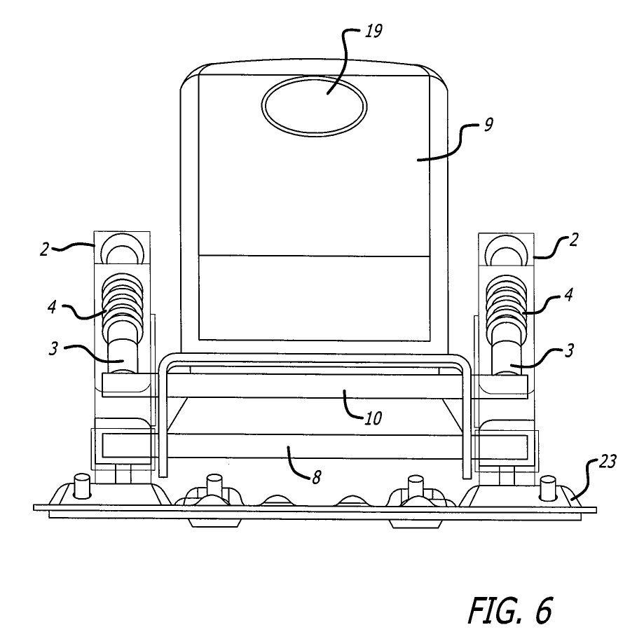

FIG. 6 is a rear elevational view of hole punch 1 shown in FIGS. 1 and 2 with body housing 6 removed and punch frame 2 cutaway to expose the internal details. The hole punch is shown in its starting rest position. A single handle 9 spanning nearly the width of the hole punch actuates, in this preferred embodiment, two punch elements 2 each with a punch pin 3. The coiled reset springs 4 can be readily seen coaxially mounted to the punch pins.

Although the present invention has been described in detail with regard to the preferred embodiments and drawings thereof, it should be apparent to those of ordinary skill in the art that various adaptations and modifications of the present invention may be accomplished without departing from the spirit and the scope of the invention. Many modifications and variations are possible in light of the above teaching. Accordingly, it is to be understood that the detailed description and the accompanying drawings as set forth hereinabove are not intended to limit the breadth of the present invention. It is intended that the scope of the invention not be limited by this detailed description, but by the claims and the equivalents to the claims appended hereto.

We claim:

1. A manually operated hole punch for punching a hole in a stack of sheet media, comprising:
a punch pin frame having a stacked media slot;
a lever pivotably mounted to the frame, wherein the lever includes a front portion in front of the pivot and a pressing area behind the pivot;
a push rod disposed at the front portion of the lever;
a jam release clip having an opening at one end to receive the push rod and an engagement member at the opposite end;
a punch pin having cutting points at one end and a base at an opposite end, the punch pin slidably fitted to the frame wherein the cutting points end passes into the stacked media slot and the base is proximate to the push rod, and wherein the engagement member of the jam release clip latches to the punch pin; and
wherein pushing at the pressing area pivots the lever in a first direction which drives the push rod into the base end of the punch pin and advances the cutting points end at least partially into the stacked media slot, and lifting up at the pressing area pivots the lever in a second direction which via the jam release clip withdraws the cutting points end at least partially out of the stacked media slot.

2. The hole punch of claim 1, further comprising a spring coaxially assembled to the punch pin.

3. The hole punch of claim 1, further comprising a spring mounted to the handle.

4. The hole punch of claim 1, wherein the opening end of the jam release clip includes a flange, and the flange hooks around and confines the base end of the push rod.

5. The hole punch of claim 1, further comprising a housing having a molded-in rib that confines an end of the pivot rod.

6. The hole punch of claim 1, wherein the engagement member includes two parallel fingers that engage a complementary formation in the punch pin.

7. The hole punch of claim 1, wherein the engagement member includes two parallel fingers with interior flat surfaces that engage complementary flat surfaces of respective slots in the punch pin, wherein the complementary flat surfaces prevent rotation of the punch pin relative to the jam release clip.

8. A manually operated hole punch for punching at least one hole in a stack of sheet media, comprising:
a base plate;
a punch pin frame secured to the base plate;
a pivot rod disposed at one side of the punch pin frame;
a handle hinged on the pivot rod wherein a front portion of the handle is disposed at one side of the pivot rod and a pressing area of the handle is disposed at an opposite side of the pivot rod;
a push rod connected to the handle at the front portion;
a U-shape jam release clip coupled to the push rod, wherein the push rod passes through a hole adjacent to a first end of the jam release clip and formed in a side of the clip, the jam release clip having at least a pair of parallel fingers with flat inner edges at a second end of the clip; and
a punch pin, the punch pin having at least two flat grooves formed therein, wherein the jam release clip extends alongside the punch pin and the flat grooves of the punch pin are engaged by the flat inner edges of the jam release clip to secure the pin to the clip.

9. The hole punch of claim 8, wherein the push pin frame includes a round passage passing through the frame.

10. The hole punch of claim 9, wherein the pin is slidably guided within the round passage of the push pin frame.

11. The hole punch of claim 8, wherein the frame includes an L-shaped foot at a bottom of the frame and a downward extending alignment tab at an opposite end of the bottom to the L-shaped foot such that the L-shaped foot hooks into the base plate and the tab secures the frame in to the base plate.

12. The hole punch of claim 8, further comprising a spring coaxially assembled to the cylindrical punch pin and positioned between an inner part of the punch pin frame and the second end of the jam release clip.

13. The hole punch of claim 8, further comprising a reset spring mounted to the handle.

14. The hole punch of claim 8, wherein the jam release clip includes a flange at the first end of the jam release clip, and wherein the flange hooks around and confines an end of the push rod.

15. The hole punch of claim 8, further comprising a housing having a molded-in rib that confines an end of the pivot rod.

16. The hole punch of claim 15 wherein the molded-in rib confines an end of the push rod.

17. The hole punch of claim 8, wherein the hole in the clip includes an elongated shape.

18. The hole punch of claim 8, wherein the cylindrical punch pin includes a V-notch cutting point at one end.

19. A manually operated hole punch for punching a hole in a stack of sheet media, comprising:
a punch pin frame having a stacked media slot;
a lever pivotably mounted to the frame, wherein the lever includes a front portion on one side of the pivot and a pressing area on another side of the pivot;
a push rod disposed at the front portion of the lever;
a U-shaped jam release clip having an opening at one end and an engagement member at the opposite end, wherein the opening receives the push rod;
a means for cutting having a cutting end and a base at an opposite end, the means for cutting slidably fitted to the frame to advance the cutting end into the media slot, wherein the jam release clip extends alongside the cutting means and the engagement member of the jam release clip latches to the cutting means; and
wherein pushing on the pressing area pivots the lever in a first direction which drives the push rod into the base end of the cutting means and advances the cutting end at least partially into the stacked media slot, and lifting up on pressing area pivots the lever in a second direction which via the jam release clip withdraws the cutting end at least partially out of the stacked media slot.
